(19) United States
(12) Patent Application Publication
(10) Pub. No.: US 2021/0339923 A1
(43) Pub. Date: Nov. 4, 2021

(54) PLASTIC CONTAINER FOR PACKAGING OF OXYGEN-SENSITIVE PRODUCTS AND METHOD OF MAKING THE SAME

(71) Applicant: MuCell Extrusion, LLC, Woburn, MA (US)

(72) Inventors: Mehdi Saniei, Belmont, MA (US); Mark E. Lindenfelzer, Milton, MA (US); Eric V. Fredrickson, Lancaster, MA (US)

(73) Assignee: MuCell Extrusion, LLC, Woburn, MA (US)

(21) Appl. No.: 17/232,745

(22) Filed: Apr. 16, 2021

Related U.S. Application Data
(60) Provisional application No. 63/010,891, filed on Apr. 16, 2020.

(51) Int. Cl. B65D 65/40; B32B 27/06; B32B 27/32; B32B 27/18; B29C 49/00; B29C 49/04; B29C 49/22

(52) U.S. Cl. CPC B65D 65/40; B29K 2105/0088; B32B 27/32; B32B 27/18; B29C 49/0005; B29C 49/04; B29C 49/22; B32B 2270/00; B32B 2307/7244; B32B 2266/08; B32B 2307/732; B32B 2307/72; B32B 2250/242; B32B 2250/40; B32B 2439/00; B32B 27/065

(57) ABSTRACT

Plastic containers and methods of forming the same are described. In some cases, the container is a recyclable multilayer extrusion blow-molded plastic container comprising high-density polyethylene with an enhanced oxygen barrier properties. The containers may be used for direct and non-direct food contact packaging, liquid packaging, as well as in aseptic packaging applications. The containers can have an oxygen transmission rate, according to ASTM D3985, of less than 10 cc/m².day. The containers can be recycled in the HDPE recycling stream.

### RELATED APPLICATION

This application claims priority to U.S. provisional patent application No.: 63/010,891 filed on Apr. 16, 2020, which is incorporated herein by reference in its entirety.

### FIELD

This invention relates to a multilayer (e.g., extrusion blow molded) container which, for example, may be used for packaging of oxygen-sensitive products.

### BACKGROUND

As the food consumers' expectations for the quality of the foodstuff itself as well as the quality of the packaging increases, the food producers and packaging companies are facing more challenges in providing the market with healthy and fresh food with least amount or none of the chemical preservatives, and with a decent packaging quality. The development of new technologies that can significantly contribute to preserving the edible products during a more extended time is vital in the supply chain and the shelf life of the food products in stores. This is because many food products are prone to go rancid or degrade when they exposed to oxygen. For example, Raw milk deteriorates in only a few days, even when stored under refrigeration temperatures. Milk that is pasteurized at high temperature for a short time (HTST) can have a shelf life of 7 to 28 days if kept refrigerated. Obviously, any poor cold chain condition that might prevail during the supply chain, which makes the milk undergo repeated and/or sometimes severe temperature abuse, can significantly shorten the shelf life.

The rigorous control of post pasteurization temperature and aseptic system for bottling can increase the shelf life of pasteurized milk. The advent of paper-foil-plastic laminated containers, e.g., Tetrahedron in 1959, was an inflection point in aseptic packaging industries. So, typically a layer of a metalized polymer film or aluminum film is incorporated in the structure of the paperboard, which provides an excellent oxygen barrier property. On the other hand, the existing non-metalized multilayer blow-molded high-density polyethylene (HDPE) containers have one or more layers made from ethylene-vinyl alcohol (EVOH). Although, these EVOH layers can exhibit a reasonable oxygen barrier properties but can contaminate the HDPE mono-material stream for recycling.

So, it would be beneficial to develop a recyclable blow-molded HDPE container which exhibits an enhanced oxygen barrier property that may be used for the storage of oxygen-sensitive products.

### SUMMARY

Plastic containers and processes for forming the same are described herein.

In some aspects, a multilayer plastic container is provided. The contaier comprises at least three layers including one or more inner layers between two solid skin layers. The solid skin layers comprise polyethylene (PE). At least one of the inner layers comprises a blend of PE/EVOH. The blend comprises from about 30 to 50 percent by weight EVOH, and the overall amount of the EVOH in the container does not exceed 10 percent of the weight of the container.

In some aspects, a process of forming a multilayer plastic container comprising at least three layers including one or more inner layers between two solid skin layers is provided. The process comprises processing a first fluid stream of polymeric material comprising polyethylene in a first extruder and processing a second fluid stream of a second polymeric material comprising a blend of an olefinic resin and EVOH in a second extruder. The blend comprises from about 30 to about 50 percent by weight EVOH. The process further comprises co-extruding the first fluid stream and the second fluid stream through a parison die to form a multilayer parison comprising two polyethylene layers and a layer comprising the second polymeric material. The proces further comprises blowing molding the parison into a mold or a vessel to form a container. The container comprises at least three layers including one or more inner layers between two solid skin layers. The one or more inner layers comprises the second polymeric material and the two solid skin layers comprise polyethylene.

In some embodiments, the product may have an oxygen transmission rate of less than 10 cc/m²/24 hr, according to ASTM D3985.

In some embodiments, the product may have a water vapor transmission rate of less than 2 gr/m²/24 hr, according to ASTM E398-13.

Other aspects, embodiments, advantages, and features may become apparent from the following detailed description.

### DETAILED DESCRIPTION

The singular forms “a,” “an,” and “the” include plural referents unless the context clearly dictates otherwise.

All ranges disclosed herein are inclusive of the recited endpoint and independently combinable (for example, the range of the EVOH content from 30 to 50 percent by weight is inclusive of the endpoints, 30 and 50, and all the intermediate values. In the same context, for example, the overall EVOH content less than 50 percent by weight is inclusive of the endpoint, 50 wt %.)

As used herein, approximating language may be applied to modify any quantitative representation that may vary without resulting in a change in the basic function to which it is related. Accordingly, a value modified by a term or terms, such as “about” and “substantially,” may not be limited to the precise value specified. The modifier “about” should also be considered as disclosing the range defined by the absolute value of the two endpoints. For example, the expression “from about 30 to about 50” also discloses the range “from 30 to 50”.

As used herein, the term “container” also includes bottles, and both terms also included tapered and non-tapered neck forms.

As used herein, the term “skin layers” refers to the two outer most layers of a multi-layer structure. For a container, one skin layer defines the outer surface of the container and one skin layer defines the inside surface of the container. The term “inner layers” refers to layers that are between the skin layers.

The present disclosure relates to multilayer (e.g., extrusion blow molded) container suitable to be used in the packaging of oxygen-sensitive products and foods, e.g., pasteurized products, baby foods, liquid food and beverages such as water, juice drinks, cold brew coffee and all kinds of coffee-based drinks, all sorts of ice tea and herbal beverages, broths, soups, milk and all sorts of prodcts derived from milk, concentrates, all kinds of dressing, e.g., ketchup; liquid egg, all kinds of edible oils, e.g., olive oil, vegetaable oil, canola oil, and tomato products; packaging of dry food products such as biscuits, cookies, cereals, variety of nuts, tea, coffee, sugar, flour, dry food mixes, chocolates, sugar confectionaries, pet food. The container described herein may be used in aseptic packaging for any kind of beverage or liquid food that may be stored at room temperature. The container described herein may be used in modified atmosphere packaging. The container can also be used in the packaging of all kinds of laundry detergents, shampoos, and body washes. The container described herein can be used in the packaging of potable water, all kinds of vitamin beverages and caffeinated beverages. The products described in all embodiments may be used for the packaging of, but not limited to, all sorts of oxygen-sensitive chemicals, petrol tank, aggressive chemicals, and motor oil.

The above-mentioned examples do not put any limitation on the application of the product of this disclosure, and other applications may be possible.

Herein a recyclable plastic container with an enhanced oxygen barrier property, fabricated using extrusion blow-molding process wherein a parison comprising one or more layers is blow-molded into a vessel or a mold to form a container, is disclosed. The container is formed from a multilayer parison which is formed in a co-extrusion process wherein an assembly of multiple extruders are used. The multilayer container comprises polyethylene (PE), e.g., HDPE. In general, the multilayer container includes one or more inner layers formed between two solid skin layers, wherein at least one of the inner layers (and, in some caeses, all of the inner layer(s)) is a polymer blend of PE/ethylene vinyl alcohol (EVOH), e.g., HDPE/EVOH, comprising up to 50 percent by weight EVOH, e.g., from about 30 to 50 percent by weight, in some cases, from about 35 to 50 percent by weight, in some cases, from about 40 to 50 percent by weight, in some cases, from about 45 to 50 percent by weight, and the overall amount of the EVOH in the whole structure of one unit of the product does not exceed 10 percent of the weight of that product. In some embodiments, the overall amount of EVOH in the structure of the container does not exceed 5 percent of the weight of the container, and in some embodiment, the overall amount of EVOH in the structure of the container does not exceed 2.5 percent of the weight of the container.

In some embodiments, the blow-molded products described herein comprise one or more layers, wherein at least one layer comprises from about 30 to about 50 percent by weight EVOH, and each unit of the products comprises less than 5 percent by weight EVOH.

In some embodiments, the blow-molded container described herein comprises one or more foam layers (e.g., between two solid skin layers). In some embodiments, the blow-molded container described herein comprises one or more solid layers (e.g., between solid skin layers), wherein the one or more solid inner layers comprise from about 30 to about 50 percent by weight EVOH, in some cases, from about 40 to about 50 percent by weight, in some cases, from about 45 to about 50 percent by weight, and the overall amount of EVOH in the structure of the container does not exceed 10 percent of the weight of the container.

In some embodiments, the overall amount of EVOH in the structure of the container does not exceed 5 percent of the weight of the container, and in some embodiment, the overall amount of EVOH in the structure of the container does not exceed 2.5 percent of the weight of the container.

In some embodiments, at least 10% of the cells are closed-cell; in some embodiments, more than 50% of the cells are closed cells; and, in some embodiments, more than 75% of the cells are closed cells. As used herein, a “closed cell” refers to a cell that has cell walls that surround the cell entirely with no openings such that there is no interconnectivity to an adjacent cell.

In some embodiments, the multilayer products described herein are comprised of seven (or at least seven) layers; in some embodiments, six (or at least six) layers; in some embodiments, five (or at least five) layers; in some embodiments, four (or at least four) layers; in some embodiments, three (or at least three) layers; in some embodiments, two (or at least two) layers, and, in some embodiments, the products are monolayer. For example, a seven-layer product comprises one or more layers (e.g., an inner layer) comprising up to 50 percent by weight EVOH wherein the amount of EVOH in the whole structure does not exceed 10 percent of the weight of the product. In some other embodiments, a six-layer product comprises one or more layers (e.g., an inner layer) comprising up to 50 percent by weight EVOH wherein the amount of EVOH in the whole structure does not exceed 10 percent of the weight of the product. In some cases, a three-layer product comprises up to about 30 to about 50 percent by weight EVOH in the middle layer wherein the amount of EVOH in the whole structure does not exceed 10 percent of the weight of the product. In one case, a monolayer product comprises up to 50 percent by weight EVOH. In another embodiment, the products described herein, which can be seven, six, five, four or three layers, comprises at least one foam inner layer and/or, in some cases one solid inner layer, and two solid skin layers. In some other embodiments, the products comprise five or four layers. It should be understood that other layer configurations may be possible.

In some embodiments, the product described herein is monolayer comprising a blend of PE/EVOH wherein the content of EVOH is less than 50 percent by weight and can be fabricated using an injection blow molding process.

Embodiments of the recyclable multilayer products, e.g., containers, described herein can exhibit an enhanced oxygen barrier properties compared to conventional products. In some embodiments, the products have an oxygen transmission rate, according to ASTM D3985, of less than 20 cc/m²/day; in some cases, less than 15 cc/m²/day; in some cases, less than 10 cc/m²/day; in some cases, less than 5 cc/m²/day; in some cases, less than 2 cc/m²/day, and in some cases, less than 1 cc/m²/day

In some embodiments, the products can have a water vapor transmission rate of less than 5 gr/m²/day, according to ASTM E398-13; In some other case, the water vapor transmission rate of less than 2 gr/m²/day, and in some cases, less than 1 gr/m²/day.

In some embodiments, the described product comprises at least one layer comprising a resin that has an oxygen transmission rate value of less than 10 cc/m²/day/mil, according to ASTM D3985. In another embodiment, the described products may have at least one layer, excluding the solid skin layers, comprising a polymer blend comprising ethylene vinyl alcohol (EVOH).

In some embodiments, the products described herein are lightweight and have a bulk density of less than 1 gr/cm³.

In some embodiments, at least one layer (e.g., skin layers, at least one inner layer, all inner layers) of the described products, e.g., containers, comprises HDPE. In some cases, the polymeric material in one or more of these layers consists essentially of HDPE and, in some cases, the polymeric materials in at least one of the solid layers, excluding the solid skin layers, comprises EVOH. In some embodiments, the overall amount of EVOH in the container described herein does not exceed 10 percent of the total weight of the same container. In some embodiment, the overall amount of EVOH in the structure of the container does not exceed 5 percent of the weight of the container, and in some embodiment, the overall amount of EVOH in the structure of the container does not exceed 2.5 percent of the weight of the container. In one embodiment, at least one layer of the multilayer film can comprise LDPE.

In some embodiments, the monolayer container described herein can be produced by extrusion blow molding process, injection blow molding process, or other suitable methods.

In some embodiments, the polymer composition of each layer may comprise some apt amounts of other additives, such as pigments, slip agents, antistatic agents, UV stabilizers, antioxidants, nucleating agents, or clarifying agents.

In some embodiments, at least one layer comprises less than 20 percent by weight of an inorganic additive, e.g., talc. In some embodiments, at least one layer comprises less than 15 percent by weight; in some embodiment, less than 10 percent by weight; and in some embodiments less than 5 percent by weight of an inorganic additive, e.g., talc. In some other embodiments, at least one layer comprises less than 40 percent by weight of an inorganic additive, e.g., clay or nanoclay; in some embodiment, less than 30 percent by weight; in some embodiment, less than 15 percent by weight; and in some embodiments, less than 5 percent by weight

In some embodiments, one or more layers of the products described herein comprise less than 5 percent by weight maleic anhydride (MA); in some embodiments, less than 3 percent by weight MA; and in some embodiments, less than about 1 percent by weight MA.

In some embodiments, the foam layer(s) optionally may contain 0.05 to 15 percent by weight of an inorganic additive, an organic additive or a mixture of an inorganic and an organic additive as a nucleating agent. In some embodiments, the foam layer(s) optionally may contain from about 1 to 15 percent by weight; in some embodiments, from about 2.5 to 15 percent by weight; in some embodiment, from about 5 to 15 percent by weight; in some embodiments, from about 7.5 to 15 percent by weight; in some embodiment, from about 10 to 15 percent by weight; and in some embodiments, from about 12.5 to 15 percent by weight of an inorganic additive, an organic additive or a mixture of an inorganic and an organic additive as a nucleating agent. For example, the foam layer(s) may contain up to about 15% by weight of talc as a nucleating agent. In some embodiments, at least one layer may include a clarifying agent at less than 1 percent by weight, such as less than 0.5 percent by weight, such as less than 0.1 percent by weight, such as less than 0.05 percent by weight. In some cases, at least one layer of the film may contain up to about 35wt % of calcium carbonates. In another exemplary embodiment, the outer skin layer of the products may contain up to about 25 wt % talc.

In some embodiments, the skin layers of the container described herein are solid layers comprising HDPE. In some embodiments, the inner most skin layer of the container (i.e., the layer of the container that would be in direct contact with the contents (e.g., food products) in the container) is a solid layer comprising an FDA approved HDPE.

In some cases, the multilayer container described herein can be comprised of two solid skin layers wherein at least one of the skin layers contains an apt amount of black pigments, for example, less than 1 percent by weight, and the other solid skin layer may contain apt amounts of white pigments, for example, less than 1 percent by weight; in some cases both solid skin layers contains some apt amounts of white pigments. In some cases, at least one of the layers of the multilayer container described herein comprises black pigments.

In some embodiments, the products described herein can have an overall thickness of greater than 10 mils, in some cases, greater than 12 mils, in some cases, greater than 15 mils, and in some cases greater than 20 mils. In some other embodiments, other layer thicknesses less than 10 mils with described layer configurations may be possible. In some embodiments, the overall thickness of the products is less than 25 mils.

In some embodiments, the thickness of the foam layer (s) in the disclosed product is less than 500 μm, in some embodiment, less than 350 μm, I some embodiments, less than 250 μm, in some embodiments, less than 200 μm, and in some embodiments, less than 100 μm.

In some embodiments of the disclosed product, the thickness of the layer(s) comprising EVOH is less than 250 μm, in some embodiments, less than 200 μm, in some embodiments, less than 150 μm, in some embodiments, less than 100 μm, and in some embodiments, less than 50 μm.

In some embodiments, the foam layer(s) of the disclosed lightweight products can have uniformly distributed cells, for example with a closed-cell morphology, an average cell size of about 10-250 μm, an average cell density with respect to the un-foamed volume of about 10²-10⁹ cells/cm³, and an expansion ratio of the foamed layer from 1 to 9. In some embodiment, the average cell size of the cells in the foam layer is less than 250 μm, in some embodiments, less than 200 μm, in some embodiments, less than 150 μm, in some embodiments, less than 100 μm, in some embodiments, from 75 μm, and in some embodiment less than 50 μm. In some cases, the average cell size of the cells in the foam is greater than 10 μm (e.g., greater than 10 μm and less than 100 μm). In some cases, the foam layer comprises more than 50% closed cells, in some cases, more than 75% closed cells, in some cases, more than 85% closed cells, and in some cases, more than 90% closed cells. In one embodiment, the foam layer has a substantially entirely closed-cell morphology (e.g., greater than 95% closed cells). In some embodiments, the density of the foam layer(s) of the disclosed lightweight product is less than 0.99 gr/cm³, in some cases, less than 0.85 gr/cm³, in some case, less than 0.75 gr/cm³, in some case, less than 0.65 gr/cm³, in some cases, less than 0.55 gr/cm³, in some cases, less than 0.45 gr/cm³, in some cases, less than 0.35 gr/cm³, in some cases, less than 0.25 gr/cm³, in some cases, less than 0.15 gr/cm³, in some cases, less than 0.1 gr/cm³. In some embodiments, the density of the foam layer(s) of the disclosed lightweight product is from about 0.1 to 0.95 gr/cm³, in some case, from about 0.2 to 0.95 gr/cm³, in some case, from about 0.3 to 0.95 gr/cm³, in some case, from about 0.4 to 0.95 gr/cm³, in some case, from about 0.5 to 0.95 gr/cm³, in some case, from about 0.6 to 0.95 gr/cm³, in some case, from about 0.7 to 0.95 gr/cm³, in some case, from about 0.8 to 0.95 gr/cm³, in some case, from about 0.9 to 0.99 gr/cm³.

In some embodiments, at least one layer of the multilayer products described herein comprises polyethylene (PE), e.g., HDPE, LDPE, LLDPE copolymer, which includes an α-olefin co-monomer such as butene, hexene, octene, or polypropylene (PP). In some embodiments, at least one layer of the multilayer products described herein preferably comprises HDPE.

In some embodiments, at least one layer of the multilayer products described herein comprises from about 0 wt % to about 100 wt % recycled materials, e.g., rHDPE, post-consumer regrinds, e.g., PCR HDPE, or post-industrial regrinds, e.g., HDPE. In some embodiments, at least one layer of the multilayer products described herein comprises from about 10 wt % to about 100 wt % recycled materials, In some embodiment, from about 25 wt % to about 100 wt % recycled materials, in some embodiment, from about 50 wt % to about 100 wt % recycled materials, in some embodiments, from about 75 wt % to about 100 wt % recycled materials, in some embodiments, from about 85 wt % to about 100 wt % recycled materials, and in some embodiments, from about 95 wt % to about 100 wt % recycled materials.

In some embodiments, at least one layer of the multilayer products described herein comprises ethylene vinyl acetate (EVA), ethylene vinyl alcohol (EVOH), polyvinyl chloride (PVC), polyvinylidene chloride (PVDC), polyamide (PA), polyethylene terephthalate (PET), any of the resins known as TPE family such as, but not limited to, propylene-ethylene copolymer, thermoplastic olefin (TPO), and thermoplastic polyurethane (TPU).

In another embodiment, at least one layer (e.g., excluding the outer skin layers) of the product may comprise LDPE, PP, PA, EVOH, EVA, or PVOH.

Herein a process of making a recyclable blow-molded multilayer container is disclosed, comprising: processing a first fluid stream of polymeric material comprising an olefinic resin, e.g., PE, in an extruder; processing a second fluid stream of a second polymeric material comprising a blend of an olefinic resin and EVOH, e.g., PE/EVOH, in an extruder wherein the blend comprises from about 30 to about 50 percent by weight EVOH; and co-extruding the first fluid stream and the second fluid stream through a parison die to form a multilayer parison comprising a polyethylene layer and a layer comprising the second polymeric material, and, for example, the concentration of EVOH in the total throughput stream may be less than 10 percent by weight in every pound of the materials combined that are processed per hour per one inch of the parison die; then the resulting parison is blow-molded into a mold or a vessel to form a container. In some embodiment, the overall amount of EVOH in the total throughput stream is less than 5 percent in every pound of the materials combined that are processed per hour per one inch of the parison die, and in some embodiment, the overall amount of EVOH is less than 2.5 percent.

Herein a process of making a lightweight recyclable blow-molded multilayer container is disclosed, comprising: processing a first fluid stream of polymeric material comprising an olefinic resin, e.g., PE, in an extruder; processing a second fluid stream of a second polymeric material comprising a blend of an olefinic resin and EVOH, e.g., PE/EVOH, in an extruder wherein the blend comprises from about 30 to about 50 percent by weight EVOH wherein a supercritical physical blowing agent is introduced into the first fluid stream and/or the second fluid stream in the extruder; and co-extruding the first fluid stream and the second fluid stream through a parison die to form a multilayer parison comprising at least one foam layer, and the concentration of EVOH in the total throughput stream is less than 10 percent by weight in every pound of the materials combined that are processed per hour per one inch of the parison die; then the resulting parison is blow-molded into a mold or a vessel to form a container. In some embodiment, the overall amount of EVOH in the total throughput stream is less than 5 percent in every pound of the materials combined that are processed per hour per one inch of the parison die; and in some embodiment, the overall amount of EVOH is less than 2.5 percent.

In some embodiment, the blowing agent used in the process of making the lightweight product described can be N₂, CO₂, a mixture of N₂ and CO₂, or any other chemical blowing agent known in the art.

1. A multilayer plastic container comprising at least three layers including one or more inner layers between two solid skin layers, wherein the solid skin layers comprise polyethylene (PE), wherein at least one of the inner layers comprises a blend of PE/EVOH, the blend comprises from about 30 to 50 percent by weight EVOH, and the overall amount of the EVOH in the container does not exceed 10 percent of the weight of the container.

2. The container of claim 1 wherein the blend is HDPE/EVOH and comprises from about 45 to 50 percent by weight EVOH.

3. The container of claim 1, wherein the container has an oxygen transmission rate of less than 10 cc/m²/24 hr, according to ASTM D3985.

4. The container of claim 1, wherein at least one layer comprises other additives to include pigments, slip agents, antistatic agents, UV stabilizers, maleic anhydride, and antioxidant.

5. The container of any preceding claim 1, comprising one or more foam layers wherein at least 10% of the cells in one or more foam layers are closed-cell.

6. The container of claim 1, comprising one or more foam layers wherein the thickness of the one or more foam layers is less than 500 μm.

7. The container of claim 1, wherein the thickness of the one or more inner layers comprising the blend of PE/EVOH is less than 100 μm.

8. The container of claim 1, wherein one or more layers comprise from about 10 to 100% recycled polyethylene.

9. The container of claim 1, comprising a foam layer, wherein the foam layer comprises an inorganic additive, an organic additive or a mixture of two as nucleating agent.

10. The container of claim 1, comprising a foam layer wherein the foam layer comprises nucleating agent with a content of 0.05 to 15 percent by weight of an inorganic additive, an organic additive, or a mixture of an inorganic and an organic additive.

11. The container of any preceding claim 1, comprising a foam layer wherein the average cell size in the foam layer is from about 10 to 100 μm.

12. The container of claim 1, comprising a foam layer, wherein the cell density with respect to the un-foamed volume in the foam layer is 10² to 10⁹ cells/cm³.

13. The container of claim 1, comprising a foam layer, wherein the density of the foam layer is from about 0.1 to 0.9 g/cm³.

14. A process of making a multilayer plastic container comprising at least three layers including one or more inner layers between two solid skin layers, the process comprising:
processing a first fluid stream of polymeric material comprising polyethylene in a first extruder;
processing a second fluid stream of a second polymeric material comprising a blend of an olefinic resin and EVOH in a second extruder, wherein the blend comprises from about 30 to about 50 percent by weight EVOH; and
co-extruding the first fluid stream and the second fluid stream through a parison die to form a multilayer parison comprising two polyethylene layers and a layer comprising the second polymeric material; and
blow molding the parison into a mold or a vessel to form a container, wherein the container comprises at least three layers including one or more inner layers between two solid skin layers, wherein the one or more inner layers comprises the second polymeric material and the two solid skin layers comprise polyethylene.

15. A process of making a multilayer plastic container as in claim 14 wherein the second polymeric material comprises a blend of HDPE/EVOH comprising from about 45 to 50 percent by weight EVOH.

16. A process of making a multilayer container as in claim 14, wherein the container is recyclable and wherein a supercritical physical blowing agent is introduced into the first fluid stream and/or the second fluid stream in the extruder; and co-extruding the first fluid stream and the second fluid stream through a parison die to form a multilayer parison comprising at least one foam layer; then the resulting parison is blow-molded into a mold or a vessel to form a container.

17. A process of making a multilayer container as in claim 14, wherein the concentration of EVOH in the total throughput stream is less than 10 percent by weight in every pound of the materials combined that are processed per hour per one inch of the parison die.

18. A process of making a multilayer container as in claim 16 wherein the supercritical blowing agent is either supercritical nitrogen or supercritical carbon dioxide, or a mixture of two.
